(19) United States
(12) Patent Application Publication
(10) Pub. No.: US 2012/0091060 A1
(43) Pub. Date: Apr. 19, 2012

(54) FILTRATION METHOD AND DEVICE

(75) Inventors: Jochen Hamatschek, Oelde (DE); Hans Olapinski, Aichwald (DE)

(73) Assignee: GEA MECHANICAL EQUIPMENT GMBH, Oelde (DE)

(21) Appl. No.: 13/203,395

(22) PCT Filed: Feb. 24, 2010
(86) PCT No.: PCT/EP2010/052323

§ 371 Date: Jan. 5, 2012

(30) Foreign Application Priority Data
Feb. 25, 2009 (DE) 10 2009 010 484.4

(51) Int. Cl. B01D 61/14; B01D 61/18; B01D 65/02

(52) U.S. Cl. 210/636; 210/650; 210/321.68; 210/321.63

(57) ABSTRACT

A filtration method for a filtration device, the filtration device including a process tank, at least one feed line feeding a medium to be processed into the process tank, and at least one filtration arrangement arranged in the process tank. The process tank includes at least one drain and is configured such that filtration of the medium is accomplished such that a retentate remains in the process tank until the retentate is released after completion of the filtration. The filtration method includes the steps of: filling the process tank with the medium to be filtered and producing one of a predefined transmembrane pressure and constant permeate flow at the at least one filtration arrangement; and filtering the medium in the process tank via the at least one filtration arrangement until a predefined limit value for a mass fraction of solid material is reached.

This application is a national stage of International Application PCT/EP2010/052323, filed Feb. 24, 2010, and claims benefit of and priority to German Patent Application No. 10 2009 010 484.4, filed Feb. 25, 2009, the content of which Applications are incorporated by reference herein.

### BACKGROUND AND SUMMARY

The present disclosure relates to a filtration method and to a filtration device for filtering a fluid medium, for example, a fluid fermentation broth.

The practice of filtering a fluid medium, such as a fermentation broth, by cross-flow filtration, giving a retentate and a permeate, is known.

Since biotechnological media are often sensitive products that require very gentle treatment, there is a requirement for a method and a filtration device for filtering fluid media, for example, fermentation broths, by which the actual filtration is likewise carried out in a particularly gentle manner. Moreover, the method must be carried out at or below critical flow conditions in order to ensure a constant capacity and a high product throughput.

See prior-art documents U.S. Pat. Nos. 5,254,250 A, U.S. 7,162,622 B2, U.S. 2008/0073264 A1, U.S. Pat. No. 6,461,503 B1, Patent Abstracts of Japan JP 05-2 20 499 A, JP 06-2 38 134 A, JP 07-2 89 861 A and JP 09-3 23 030 A.

U.S. Pat. No. 6,461,503 B1 is cited as a prior art document. In this document, the medium to be filtered is filtered by filter disks which are arranged in a vessel, which rotate and which overlap in sections, the permeate and the retentate being discharged continuously from the container. The dimensions of the vessel correspond approximately to the dimensions of the filtering arrangement in the vessel. The vessel is matched to the flow conditions at the filter disks and is generally charged via a process tank arranged upstream of the vessel.

Given this background, the present disclosure provides for a method and a device for filtering fluid media, for example, fermentation broths, by which filtration can be carried out in a manner which is particularly gentle for the product, with a relatively low outlay on apparatus and under low or critical flow conditions low, for example, transmembrane pressure.

The present disclosure thus provides for a filtration method for a filtration device, the filtration device including a process tank, at least one feed line feeding a medium to be processed into the process tank, and at least one filtration arrangement arranged in the process tank. The process tank includes at least one drain and is configured such that filtration of the medium is accomplished such that a retentate remains in the process tank until the retentate is released after completion of the filtration. The filtration method includes the following steps: filling the process tank with the medium to be filtered and producing one of a predefined transmembrane pressure and constant permeate flow at the at least one filtration arrangement; and filtering the medium in the process tank via the at least one filtration arrangement until a predefined limit value for a mass fraction of solid material is reached. The present disclosure also provides for a filtration device configured to perform the method of Claim 1. The filtration device includes a process tank and at least one feed line for supplying a medium to be processed into the process tank. At least one membrane filtration arrangement is arranged in the process tank, the at least one membrane arrangement having at least one hollow shaft on which a plurality of membrane filter disks are arranged. The at least one hollow shaft is assigned at least one drive. A permeate is discharged from the process tank through the at least one hollow shaft. The process tank has at least one drain and the process tank is configured such that the filtration of the medium to be filtered is carried out with a retentate remaining in the process tank until the retentate is released after completion of the filtration. The present disclosure further provides for a filtration system including a plurality of filtration devices as just described and the use of at least one of the filtration devices and the filtration system to filter a fermentation broth.

An advantage of the method, device, and system, according to the present disclosure, may be considered to be the fact that the process tank and the filtration arrangement, components which may be required separately, are combined by integrating the one or more filtration arrangements directly into a process tank. Together, the process tank and the at least one filtration arrangement form what may be a pump-free “filtration device” in the sense of this description. That may be advantageously supplemented by an agitating device for the purpose of producing defined flow conditions in the process tank during filtration and/or by a device for producing a constant and, what may be, low and uniform transmembrane pressure at the filtration arrangement in the process tank. In the context of this description, a plurality of interconnected filtration devices forms a filtration system. The term “transmembrane pressure” is used to refer to the pressure difference between the unfiltered side, the retentate side, and the filtrate side, the permeate side.

Both the concentrated biomass and the permeate can form a valuable material that can be subject to further processing if required.

The filtration device has a tank-like container, referred to herein as a “process tank”, which may be closed all the way around, into which one or more feed lines empty and in which the filter arrangement, which may be the at least one membrane filter arrangement, is arranged. Whereas the outflow is assigned a closing valve, enabling the outflow of retentate to be stopped during filtration until the closing valve is released.

The method, device, and system, according to the present disclosure, are preeminently suitable for gently filtering an extremely wide variety of media, for example, animal- and plant-based fermentation broths, which may be animal cells, such as mammalian cells, which are processed in a particularly gentle manner in which may be a closed, process tank.

The configuration can be designed either as a single-batch or fed-batch fermentation or as a continuous fermentation process. Since the ceramic filter disks can be designed as steam-cured, autoclaved disks, it is also possible, within the scope of the present disclosure, to arrange the filtration device directly in the process or fermentation tank.

Concentration may be carried out first, then diafiltration in the sense of washing, with replacement of liquid drawn off by another liquid. The process tank is then emptied and cleaned together with the filtration device.

The filtration method, according to the present disclosure, can be carried out at a constant transmembrane pressure (TMP) or a constant permeate flow. If a constant permeate flow is chosen, the transmembrane pressure rises during a concentration cycle or during a concentration stage. The constant permeate flow must, therefore, be moderate and precisely defined in order to prevent the transmembrane pressure from exceeding the maximum permitted temperature.

In respect of the device, according to the present disclosure, the at least one filtration arrangement according to an embodiment, is arranged in such a way in the process tank and the tank is designed and can be filled with the medium to be filtered in such a way that a liquid column is produced directly by the medium. The column produces a constant transmembrane pressure of, for example, more than 0.2 bar, for example, 0.3 bar, at the membrane filter disks.

As an alternative and/or in addition, the constant transmembrane pressure can also be produced by pressurizing the process tank with a fluid, such as a gas. The pressure range mentioned has proven advantageous for the filtration of fermentation broths. It can be achieved in a simple manner by producing a correspondingly high liquid column, with the result that the process tank may be a few meters high. It is within the scope of the present disclosure to produce a pressure difference in some other way, for example, by a vacuum or by removing filtrate from the process tank by suction. The drain from the process tank may be designed to be closable.

Advantageous embodiments of the present disclosure are discussed further herein and in the accompanying claims.

The hollow shafts of the filtration arrangements may be aligned horizontally, in which case the hollow shafts with the membrane filter disks then may project into the process tank from the outer circumference of the latter. By virtue of this arrangement, the filtration systems are easy to access and easy to handle, and the pressure difference in the liquid column is relatively small over the height of the filtration device when the transmembrane pressure is produced by a liquid column.

As an alternative, it can also be appropriate and within the scope of the present disclosure to align the hollow shafts with the membrane filter disks vertically and to have them project into the process tank from the bottom end or the top end of the process tank. This configuration offers an advantage that a plurality of filtration arrangements can be accommodated close together in a tight space in the process tank. The agitating device may then be arranged in a corresponding manner at the respective opposite end, for example, the top end or the bottom end.

A constant transmembrane pressure at the filtration disks of more than 0.2 bar may be maintained during the filtration, for example, the diafiltration step and, may be a constant transmembrane pressure at the filtration disks of less than 5 bar, for example, less than 1 bar, is maintained during the filtration, in particular the diafiltration step.

A constant transmembrane pressure refers especially to the pressure within a tolerance limit that is permissible and technically feasible for the process, in accordance with the present disclosure. A similar statement applies to the constant permeate flow.

Other aspects of the present disclosure will become apparent from the following descriptions when considered in conjunction with the accompanying drawings.

### BRIEF DESCRIPTION OF THE DRAWINGS

FIG. 1 shows a schematic illustration of a filtration device, according to the present disclosure.

FIG. 2 shows a schematically illustrated filtration system having a plurality of the filtration devices of FIG. 1.

FIGS. 3 to 8 show a schematic illustration of successive steps of a filtration method, according to the present disclosure, using the filtration system from FIGS. 1 and 2.

### DETAILED DESCRIPTION

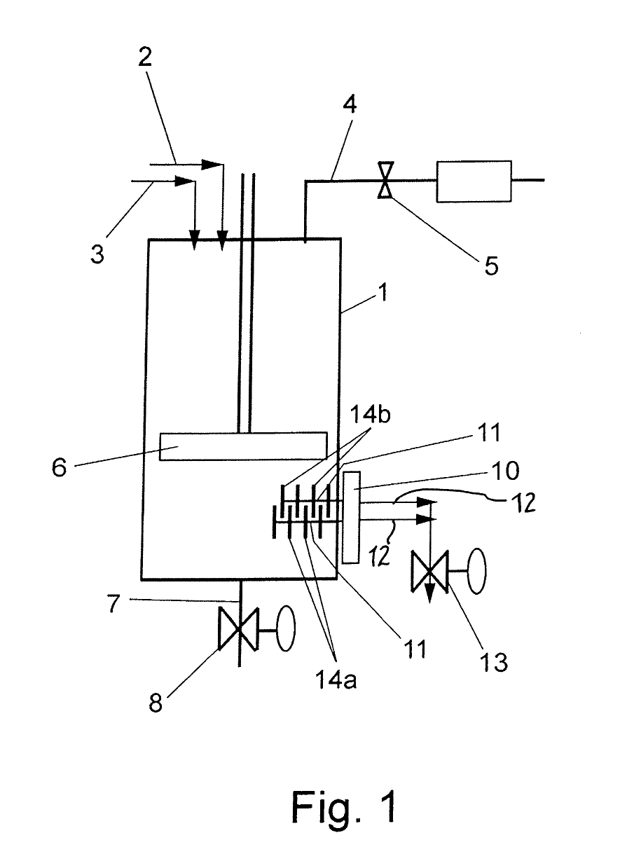

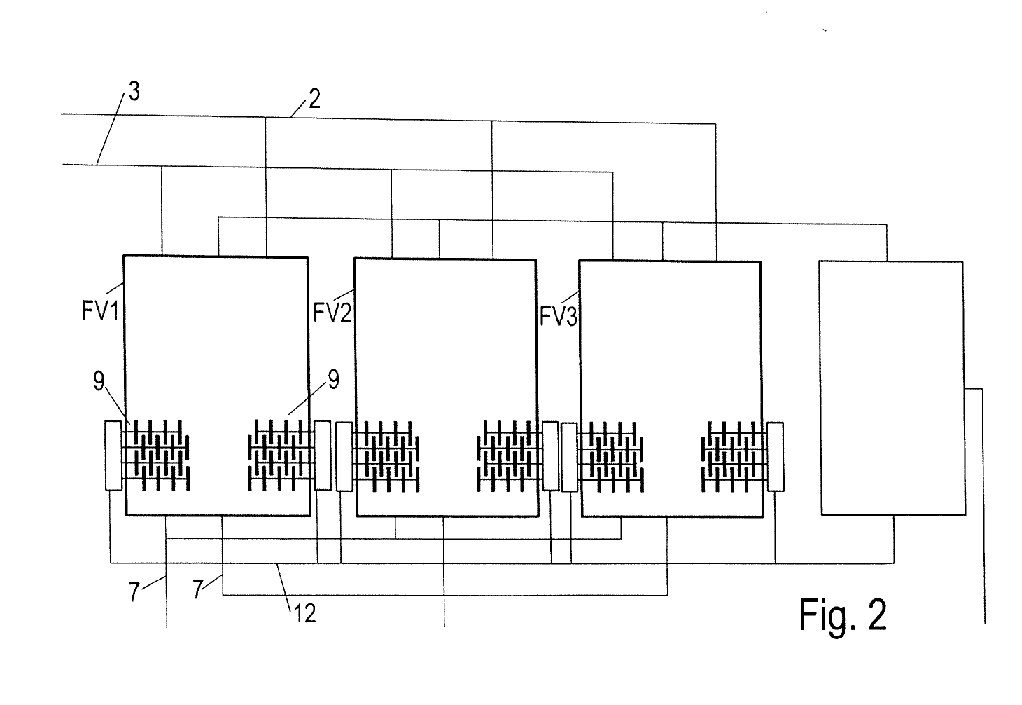

The filtration device of FIG. 1 forms part of an overall filtration system, as shown, for example, in FIG. 2.

This filtration system can, for example, form a section of a conventional fabrication system (not shown) for the production of biotechnical products, such as, for example, biotechnically produced medicaments.

According to the present disclosure, the filtration device has a tank-like container 1 closed on all sides for accommodating filtration arrangements 9 and a medium to be filtered in batch operation. This is referred to herein as a “process tank 1” into which one or more feed lines 2, 3 empty.

At least one of the feed lines, for example, feed line 2 is used to feed a fermentation broth into the process tank 1.

Either the same feed line 2 or another feed line 3, on the other hand, allows a cleaning liquid to be introduced into the process tank 1 for the purpose of carrying out a cleaning operation, especially cleaning in place (CIP).

An optional additional feed line 4 makes it possible to supply the process tank 1 with air or gas, for example, inert gas, if appropriate under pressure, for which purpose a valve 5 is inserted into the feed line 4.

As shown in FIG. 1, the process tank 1 may be provided with a device for producing a flow in the process tank, for example, an agitating device 6.

The process tank 1 may have at least one drain 7, for example, at the lower vertical end, by which it can be emptied. A drain valve 8 is inserted into the drain 7.

Moreover, at least one membrane filtration arrangement 9 is arranged in the process tank 1, the filtration arrangement 9, in turn, having at least one, or two or more rotatable shafts 11 extending from at least one drive. The drive may be arranged on a flange plate 10.

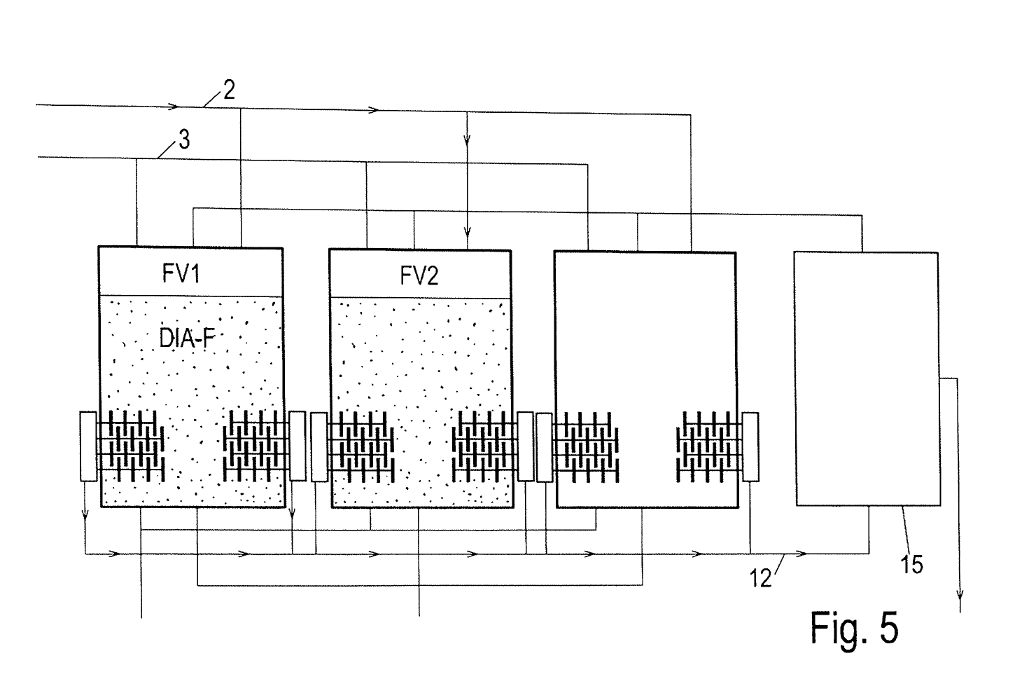

The shafts 11 are designed as hollow shafts, through which filtered liquid or filtrate is passed out of the tank 1 through a discharge line 12 (see, for example, FIG. 5) having a valve 13 (see, for example, FIG. 1). Respective membrane filter disks 14 are arranged on the shafts 11.

If just one hollow shaft with axially spaced membrane filter disks 14 is provided, an additional, stationary shaft can be provided, on which stationary disks, for example, without a filtering action, are arranged that project into the spaces between the membrane filter disks 14 in order to produce suitable flow conditions for filtration at the membrane filter disks 14 on the single hollow shaft (not shown).

The required filtration area can be adapted to give optimum operation according to the product by modular construction of the filtration arrangements.

It may be advantageous to drive two of the hollow shafts jointly. A flange plate 10 serves to close an opening in the container 1, through which the membrane filter disks 14 are inserted horizontally into the process tank 1. It is within the scope of the present disclosure, for example, to provide two or more openings in the process tank 1 in a manner distributed around its circumference. The openings are used to selectively insert an appropriate number of filtration arrangements into the process tank 1 according to requirements (not shown).

Each of the shafts 11 is provided with a plurality of membrane filter disks 14 arranged in a manner spaced apart axially on the shafts 11, the arrangement chosen being such that membrane filter disks 14a on one shaft 11 and membrane filter disks 14b on the other shaft 11 overlap radially, at least in sections. The membrane filter disks 14 can have a structure with an inner hollow chamber which opens into the hollow shaft, as known from U.S. Pat. No. 6,461,503 B1. They can furthermore include materials of the kind described in U.S. Pat. No. 6,461,503. The term “membrane filter” should thus not be taken in too narrow a sense.

In an illustrative embodiment, according to the present disclosure, the shafts 11 may be aligned horizontally since, in this way, they can be accommodated well in the process tank 1 without overextending the structure in the vertical direction and since, in this way, they may extend only over a relatively small vertical height, thus ensuring that the pressure difference in the liquid to be filtered over the height of the filtration arrangement is relatively small.

As shown in FIG. 1, for example, just one membrane filtration arrangement 9 is arranged in the process tank 1.

However, it is within the scope of the present disclosure, to arrange a plurality of membrane filtration arrangements 9 in the process tank 1, in the manner described above, for example. The arrangement chosen ensures that a relatively constant transmembrane pressure prevails at the various points of the filter disks 14 in the region of the filtration arrangements 9. A necessary transmembrane pressure can be produced by pressurization with a gas, by a liquid column and/or by a vacuum and permeate backpressure (see valve 13 in FIG. 1).

An illustrative embodiment of this kind, according to the present disclosure, is shown in FIG. 2, where two of the membrane filtration arrangements 9 are shown for each process tank 1.

It is within the scope of the present disclosure, that each of the membrane filtration arrangements 9 may have more than two of the hollow shafts 11, which may be provided with mutually overlapping membrane filter disks 14.

As shown in FIG. 2, the membrane filtration arrangements 9 are each arranged in a bottom area of the vertically aligned process tanks 1, which may be, for example, of cylindrical design.

In an embodiment, according to the present disclosure, the process tank 1 has a height of several meters. It is large enough to be filled with at least three meters of fermentation broth above the filtration arrangement(s) 9. Its diameter may be, for example, more than 1 m, and may be more than 1.5 m.

The embodiment shown in FIG. 1 represents a horizontal and vertical alignment of the filtration arrangement(s) 9 in the process tank 1.

The filtration arrangement 9 operates as follows next.

Medium to be filtered flows past the rotating membrane filter disks 14, with the filtrate entering the hollow chambers of the membrane filter disks 14, which are designed as double disks, as described in U.S. Pat. No. 6,461,503 B1 for example, and are passed out of the tank through the hollow shafts 11 and the discharge line 12 connected to the outlets thereof.

Particles held back during the filtration process may result in the formation of a layer on the membrane filter disks 14, but this is at least partially removed from the membrane filter disks 14 by the flow conditions and turbulence which arise owing to the at least partial radial overlap of the membrane filter disks 14 and the rotation of the membrane filter disks 14, thus ensuring that the filtration effect is maintained over a long period of time.

In contradistinction to U.S. Pat. No. 6,361,503, however, there is no provision for outflow of retentate but, instead, the medium to be filtered is filtered and the permeate is discharged immediately, whereas the retentate remains in the process tank 1 in the course of further filtration. Instead, the retentate is released from the process tank 1 only on completion of filtration. Since the retentate remains in the process tank during filtration, there is an increase in the concentration of solids in the process tank 1. As an option, according to the present disclosure, more liquid can be added during filtration.

There is no need for pumping operations to a separately arranged filter, which impose a stress on the product and during which there is the risk of cell damage. In order to avoid upstream pumping operations in the method as well, according to the present disclosure, arrangement of an upstream reaction tank or tanks above the process tanks 1 is recommended, allowing a direct gravity feed into the process tanks 1.

For the reason stated above, it may not be possible to have genuine continuous operation of the pump-free filtration device but only batch operation. In order, nevertheless, to provide an industrially useful continuous system, it may be advantageous to connect a number of the filtration devices, as shown in FIG. 1 to form an overall filtration system and then to carry out filtration in the process tanks 1 with an offset relative to one another. An embodiment, according to the present disclosure, of such an offset is described below. However, alternative offset arrangements are within the scope of the present disclosure.

A filtration system, according to the present disclosure may, comprises a plurality of filtration devices as shown in FIG. 1. Such a configuration has proven effective since it allows quasi-continuous operation, and this is advantageous especially in industrial processes.

In the embodiment, according to the present disclosure, shown in FIG. 2, three of the filtration devices, each with a process tank 1 and two of the membrane filtration arrangements 9 arranged in the process tank 1, are connected together to form an overall filtration system. The system is connected to a common feed line 2, 3 and a common drain line 7, each of which has branches to the individual process tanks that can be shut off.

FIG. 2 shows the filtration system, which has three of the filtration devices, which are denoted by FV1, FV2 and FV3 for the sake of simplicity and which each have one of the process tanks 1 with at least one filtration arrangement 9.

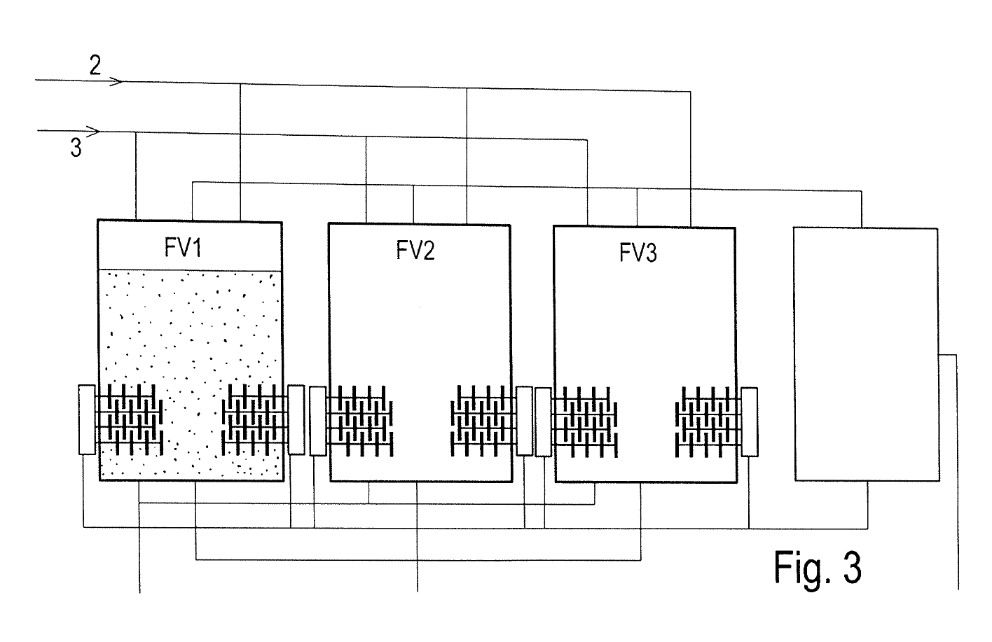

An agitating device 6, gas feed line 4 and other details are not shown in FIG. 2 since FIG. 2, like the other Figures, for example, FIGS. 3-8, is primarily intended to illustrate a method according to the present disclosure.

In a method according to the present disclosure, the process tank 1 of the filtration device denoted by FV1 is filled with a fermentation broth via the feed line 2 (see FIG. 3).

According to an embodiment of the present disclosure, the process tank 1 of filtration device FV1, which has a diameter of 2 m and a height of about 5 m, for example, is filled up to a height of at least 3 m above an upper edge of the membrane filter arrangements 9 in order to achieve a constant transmembrane pressure TMP of about 0.3 bar, for example, in the region of the filtration arrangements 9 or membrane filter disks 14 by the liquid column formed in the process tank 1 during filling. The falling level in the course of concentration leads to a change in the hydrostatic pressure, and this can be compensated by the application of gas pressure. The feed rate is initially about 4.5 to 5 m³/h for a fermentation broth consisting of yeast cultures, for example.

The percentage of biomass V (biomass)/V (fermentation broth), referred to herein for short as % V/V, is between 1 and 45% at the start, for example.

Once the process tank 1 of device FV1 has been filled, the membrane filtration arrangements 9 are put into operation. In the process, the fermentation broth is mixed by agitating device 6. It is within the scope of the present disclosure to use the drive of the filtration arrangement 9 to drive the agitating device 6. In this case, the agitating means, or device, would be arranged as an extension of hollow shafts 11.

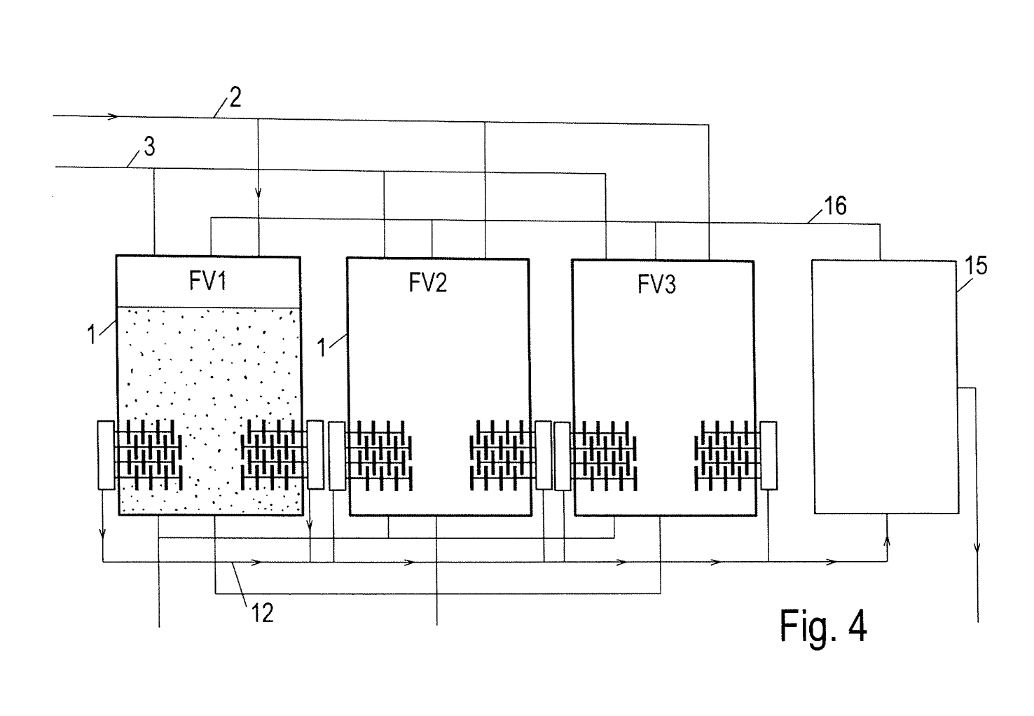

The substances retained through filtration by the membrane disks 14, the retentate, initially remain in the tank 1. The permeate, on the other hand, flows off through the discharge line 12. It forms the valuable material to be obtained from the process and to be subjected to further processing, if required. See, for example, FIG. 4.

The biomass fraction in the fermentation broth is increased by continued operation of the filtration system, which may involve continuous replacement of the outflowing volume of liquid from the process tank 1 by additional fermentation broth flowing in. See, for example, FIG. 4. This filtration is continued until a concentrated biomass volume fraction of, for example, 40-90% V/V, or, for example, 60-70% V/V, in the fermentation broth is reached. The addition of further fermentation broth during the concentration process may not be absolutely essential.

The permeate is discharged via the discharge lines 12. The discharge lines 12 empty jointly into an intermediate tank 15, which serves as an optional intermediate tank that can be arranged upstream of a further processing stage, for example, an additional filtration stage.

Process water from the additional filtration stage can be temporarily stored in an intermediate tank 15. It is within the scope of the present disclosure, to return the temporarily stored water, at least in part, into the tanks 1 via a feed line 16, in the case of a subsequent wash-type diafiltration step for example, which is discussed below.

The concentration of the fermentation liquid is continued up to a pre-defined biomass concentration limit, which corresponds to a biomass fraction of more than 50% V/V, for example.

As soon as this value is reached, another filtration stage, which is carried out as a wash-type diafiltration, is started in filtration device FV1. See, for example, FIG. 5.

During this diafiltration, no further fermentation broth 1 is added to the process tank 1 but outflowing permeate is replaced at least partially by some other liquid, for example, by process water or a buffer from the permeate, suitably processed if required. This processing stage is not shown. During this process, a constant transmembrane pressure TMP that is to be specified, 0.3 bar for example, may furthermore be maintained at the filtration disks 14. During the diafiltration too, the retentate is initially not discharged but is discharged only after an adequate washing operation, with the liquid being replaced by additional liquid flowing in.

The transmembrane pressure TMP at the membrane filter disks 14 may be held constant at more than 0.1 bar, for example, or at more than 0.2 bar and also, for example, at between 0.2 and 0.3 bar during the two filtration stages explained above. A process tank radius may be more than 2 m, or, for example, more than 3 m.

Simultaneously with the diafiltration in the process tank 1 of filtration device FV1, the filling of the process tank 1 of the second filtration device, denoted FV2, is started, as shown in FIG. 5 by feed line 3, in accordance with FIG. 3.

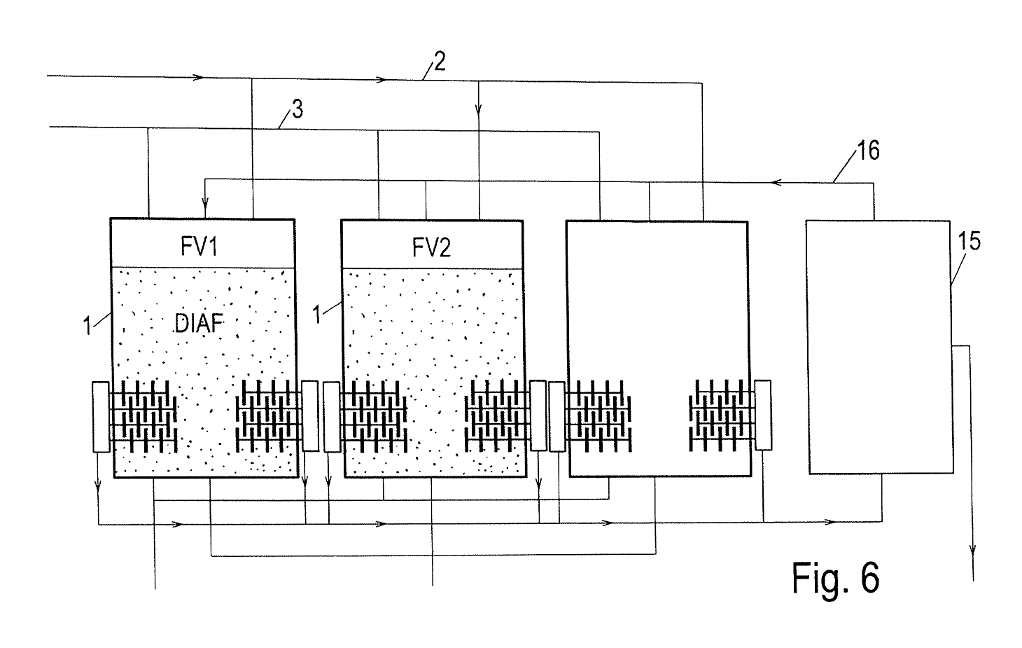

As illustrated in FIG. 6, filling of the process tank 1 of filtration device FV2 is followed in the tank 1 by the filtration and concentration of the fermentation broth with simultaneous replenishment of the process tank 1 with fermentation broth. The diafiltration in filtration device FV1 is continued.

In all filtration steps, movement in the liquid in the process tank 1 may be produced by mixing.

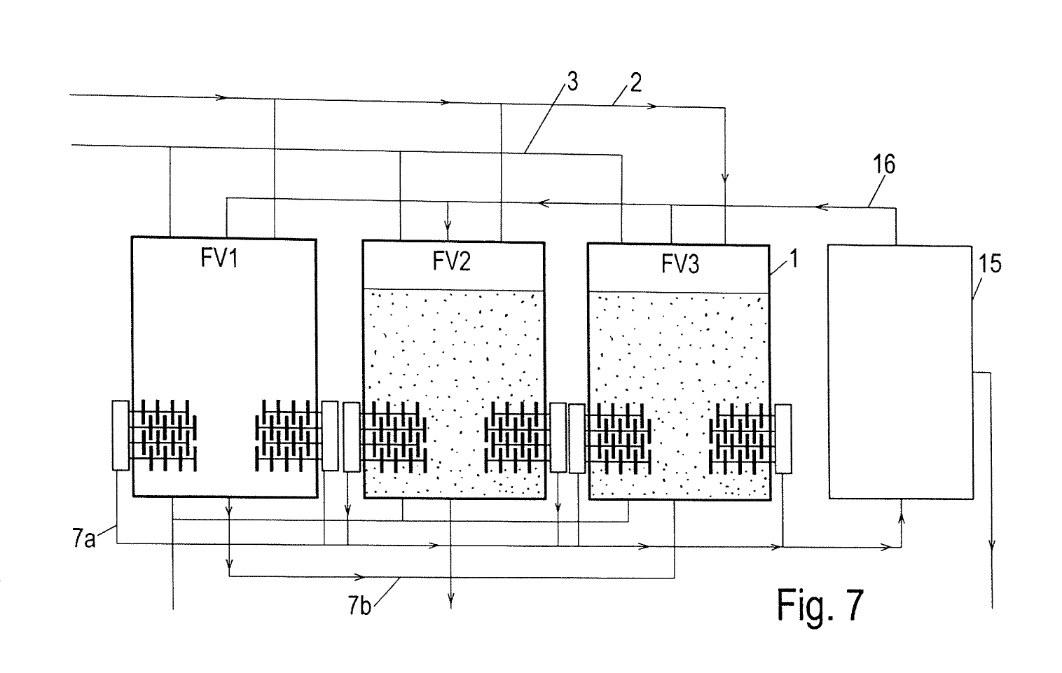

As may be seen in FIG. 7, diafiltration in filtration device FV1 is finally stopped on completion of diafiltration, for example, once certain limit values have been reached.

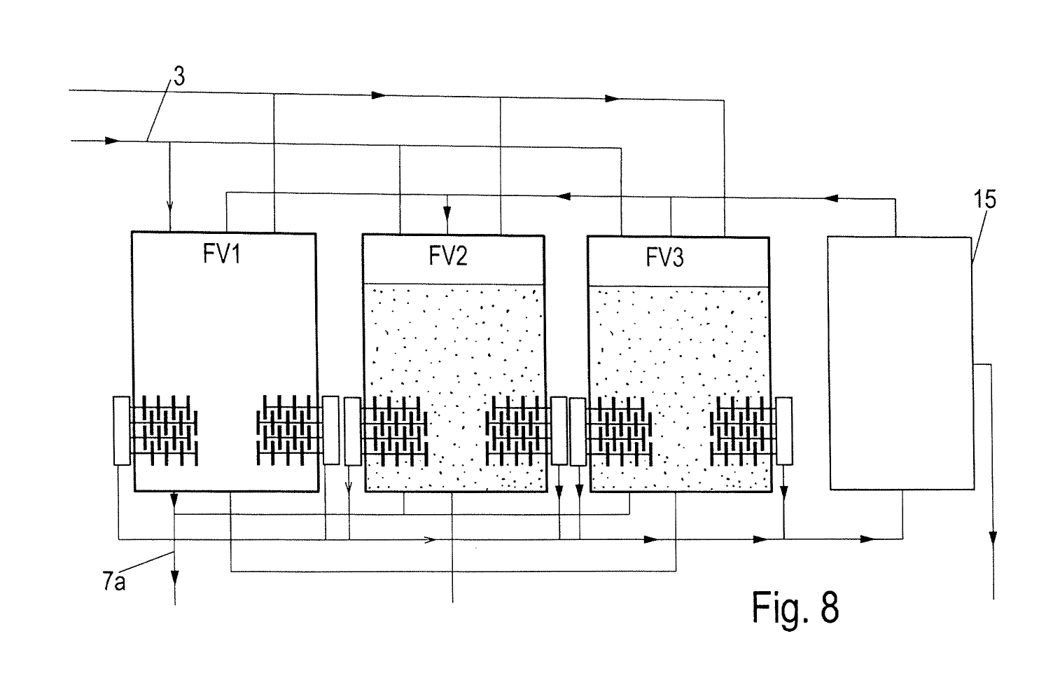

Filtration device FV1 is then emptied, it being possible for emptying of concentrated biomass (see drain 7b in FIG. 7) to take place first and emptying after cleaning of the process tank and of the filtration arrangements by cleaning in place CIP (see drain 7a in FIG. 8) to take place after this, this being shown schematically by the two different drains 7a and 7b. The biomass is put to further use, if required.

According to this embodiment, diafiltration is started simultaneously in filtration device FV2. The filling of the process tank 1 of filtration device FV3 is furthermore started. As can be seen from FIG. 8, cleaning in place CIP then starts in filtration device FV1, whereas diafiltration is continued in filtration device FV2 and the filtration stage of concentration is started in filtration device FV3, which may be accompanied by simultaneous addition of supplementary fermentation broth.

The steps run through in accordance with FIGS. 1 to 8 are then carried out in turn in an offset manner in the three filtration devices FV1, FV2 and FV3, in order in this way to allow quasi-continuous operation.

Accordingly, filtration devices FV1, FV2 and FV3 are operated in turn in an offset manner relative to one another with the following method steps:

the process tank 1 is filled, first of all, until the transmembrane pressure TMP is within a pre-defined range;

filtration of the fermentation broth in the process tank 1 is then carried out with the membrane filtration arrangements 9 while simultaneously replenishing the volume of liquid flowing off as permeate by additional fermentation broth flowing in, for example, until a pre-defined biomass fraction % V/V is reached;

a wash-type diafiltration is then carried out, in which the replenishing flow of fermentation broth is stopped and outflowing liquid is replaced by water, for example, wash water that has been separated from the permeate by a further processing operation, for example, by a further filtration; and

the retentate is then released from the process tank 1 and the process tank 1 is cleaned, if required.

These steps may take place with an offset in the various filtration devices.

FIGS. 2 to 8 describe embodiments of a filtration system according to the present disclosure, although the present disclosure is not restricted to the embodiments shown and described herein.

Thus, it is within the scope of the present disclosure to operate more than three filtration devices in parallel and to run the process steps above with the offset described, if required, or with a slightly different offset, if required.

With just three process tanks 1 and hence three filtration devices FV1, FV2 and FV3, however, it is still possible to achieve quasi-continuous operation.

The low outlay on an apparatus, that is, a small number of pumps and containers, the gentle processing, the low pressure, which is held constant, at the membrane filter disks 14 and a low flow rate in the three process tanks 1 of filtration devices FV1, FV2 and FV3 are advantageous.

Although the present disclosure has been described and illustrated in detail, it is to be clearly understood that this is done by way of illustration and example only and is not to be taken by way of limitation. The scope of the present disclosure is to be limited only by the terms of the appended claims.

We claim:

1. A filtration method for a filtration device, the filtration device including a process tank, at least one feed line feeding a medium to be processed into the process tank, at least one filtration arrangement arranged in the process tank, wherein the process tank includes at least one drain and is configured such that filtration of the medium is accomplished such that a retentate remains in the process tank until the retentate is released after completion of the filtration, the filtration method comprising the following steps:
filling the process tank with the medium to be filtered and producing one of a predefined transmembrane pressure and a constant permeate flow at the at least one filtration arrangement; and
filtering the medium in the process tank via the at least one filtration arrangement until a predefined limit value for a mass fraction of solid material is reached.

2. The filtration method as claimed in claim 1, wherein the medium in the process tank is filtered via the at least one filtration arrangement while simultaneously replenishing a volume of liquid flowing off as permeate by additional medium flowing in until the pre-defined limit value for the mass fraction of solid material is reached.

3. The filtration method as claimed in claim 1, further comprising the steps of:
further filtering via a wash-type diafiltration, with a replenishing flow of the medium that may have occurred up to this step being stopped and an outflowing permeate being replaced by an addition of a washing liquid to the process tank;
releasing a residual liquid from the process tank; and
cleaning the process tank, if required.

4. The filtration method as claimed in claim 3, wherein a flow is maintained in the process tank during one or both of the filtering step and the diafiltration step.

5. The filtration method as claimed in claim 4, wherein the washing liquid is water that is recovered from the permeate by a further treatment step.

6. The filtration method as claimed in claim 3, wherein one or more of the filtering steps is performed with the at least one filtration arrangement having at least one hollow shaft, the at least one hollow shaft having a plurality of membrane filter disks is arranged thereon, the at least one hollow shaft being assigned to at least one drive, and the permeate being discharged from the process tank through the at least one hollow shaft.

7. The filtration method as claimed in claim 1, wherein the medium in the process tank at least covers the at least one filtration arrangement.

8. The filtration method as claimed in claim 7, wherein the depth of the medium above the at least one filtration arrangement is at least one meter.

9. The filtration method as claimed in claim 6, wherein the predefined transmembrane pressure at the plurality of membrane filter disks is produced by pressurization with one or more of a gas, a liquid column above the plurality of membrane filter disks, and by a vacuum on a permeate side.

10. The filtration method as claimed in claim 1, wherein the transmembrane pressure during the filtering step is held constant.

11. The filtration method as claimed in claim 6, wherein a constant transmembrane pressure at the plurality of filtration disks of more than 0.2 bar is maintained during the filtering step.

12. The filtration method as claimed in claim 6, wherein a constant transmembrane pressure at the plurality of filtration disks of less than 1 bar is maintained during the filtering step.

13. A filtration method for carrying out a filtration of a medium to be filtered with a filtration system having a plurality of filtration devices, wherein the method steps of claim 1 are carried out with an offset relative to one another in the various filtration devices.

14. A filtration device configured to perform the method of claim 1, the filtration device including a process tank, at least one feed line for supplying a medium to be processed into the process tank, wherein at least one membrane filtration arrangement is arranged in the process tank, the at least one membrane filtration arrangement having at least one hollow shaft, on which a plurality of membrane filter disks is arranged, and wherein the at least one hollow shaft is assigned at least one drive, and wherein a permeate is discharged from the process tank through the at least one hollow shaft, and wherein the process tank has at least one drain, wherein the process tank is configured such that the filtration of the medium to be filtered is carried out with a retentate remaining in the process tank until the retentate is released after completion of the filtration.

15. The filtration device as claimed in claim 14, wherein the at least one membrane filtration arrangement is arranged in the process tank and the process tank is configured and can be filled with the medium to be filtered in such a way that the medium forms a liquid column which produces a transmembrane pressure of more than 0.2 bar and less than 1 bar at the plurality of membrane filter disks.

16. The filtration device as claimed in claim 14, wherein the process tank has a closable drain for the retentate.

17. The filtration device as claimed in claim 14, wherein the at least one membrane filtration arrangement includes a plurality of hollow shafts, and the plurality of membrane filter disks are arranged on the plurality of hollow shafts in such a way that they overlap at least radially in sections.

18. The filtration device as claimed in claim 14, wherein an agitating device is arranged in the process tank.

19. The filtration device as claimed in claim 17, wherein the plurality of hollow shafts are aligned horizontally.

20. The filtration device as claimed in claim 14, wherein the at least one membrane filtration arrangement is introduced into the process tank through an opening in the process tank and the opening in the process tank can be closed by a flange plate which the at least one membrane filtration arrangement is secured.

21. The filtration device as claimed in claim 17, wherein the at least one filtration arrangement is arranged at an outer circumference of the process tank, and the plurality of hollow shafts with the plurality of membrane filter disks project into the process tank from the outer circumference.

22. The filtration device as claimed in claim 17, wherein the at least one filtration arrangement is arranged at a bottom end of the process tank, and the plurality of hollow shafts with the plurality of membrane filter disks project into the process tank from the bottom end.

23. The filtration device as claimed in claim 17, wherein the at least one filtration arrangement is arranged at a top end of the process tank, and the plurality of hollow shafts with the plurality of membrane filter disks project into the process tank from the top end.

24. A filtration system comprising a plurality of filtration devices as claimed in claim 14, and the plurality of filtration devices are connected together.

25. A filtration system comprising three filtration devices as claimed in claim 14.

26. The filtration device as claimed in claim 14 and configured for filtering a fermentation broth.

27. The filtration method as claimed in claim 1, wherein the medium is a fermentation broth.

28. The filtration method as claimed in claim 1, wherein the predefined transmembrane pressure is a constant transmembrane pressure.

29. The filtration method as claimed in claim 1, wherein the mass fraction of solid material is a biomass fraction.

30. The filtration method as claimed in claim 6, wherein a constant transmembrane pressure at the plurality of filtration disks of more than 0.2 bar is maintained during the diafiltration step.

31. The filtration method as claimed in claim 6, wherein a constant transmembrane pressure at the plurality of filtration disks of less than 1 bar is maintained during the diafiltration step.

32. The filtration device as claimed in claim 14, wherein the medium is a fermentation broth.

33. The filtration system as claimed in claim 24, wherein the filtration devices are configured for filtering a fermentation broth.
